(19) United States
(12) Patent Application Publication
(10) Pub. No.: US 2006/0001767 A1
(43) Pub. Date: Jan. 5, 2006

(54) Enhanced structure of a photo light box

(76) Inventor: Peng Cheng Lai, Panchiao (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/880,740

(22) Filed: Jul. 1, 2004

(51) Int. Cl. H04N 5/225

(52) U.S. Cl. 348/373

(57) ABSTRACT

The present invention discloses an enhanced structure of a photo light box including a light box body having a placing space in which formed a placing gateway to inlay the lens of an image capture apparatus. A photo object is placed in the light box body for being shot and producing an image. The image capture apparatus includes a power cable and a signal cable separately connected to an internal power socket and an internal signal socket. A power socket and several signal sockets connected to the internal signal socket are formed on surface of the light box body. The power socket is connected to an external power socket for providing power, and the signal socket is connected to a computer. In addition, a light source provides the image capture apparatus with light while shooting the photo object. A control apparatus is used to connect the internal power socket, the light source and the power socket. The present invention can be applied to the image capture apparatus of different types, and have multi functions without the signal decay.

### BACKGROUND OF THE INVENTION

1. Field of the Invention

The invention relates to a photo light box, and more particularly, to an enhanced structure of a photo light box.

2. Description of the Prior Art

The skill to take a clear and accurate picture is very important for completely presenting merchandise or goods to the consumers. When taking pictures indoors, the pictures may be not good enough since the unnecessary miscellaneous objects and the disorderly light. Hence, the photo light box is popular among the factories because that the photo light box can be used to take a wonderful merchandise picture and bring a business.

In general, the light box is not integrated with an image capture apparatus, and is not using the signal cable sockets or a hole opening on light box to connect with computer in order to control the lighting and the image capture apparatus. In addition, the conventional photo light box can be only placed the digital cameras of same type, and cannot be applied to different types. By the way, the digital camera must be equipped on the fixing stand at a fixing position or be moved only on the frame and upon the photo light box. The conventional photo light box can only be applied to the photograph of commerce purpose.

Hence, the present invention discloses an enhanced structure of the photo light box to solve the above-mentioned disadvantages.

### SUMMARY OF THE INVENTION

It is therefore a primary objective of the claimed invention to provide an enhanced structure of a photo light box that the power cable and the signal cable can be orderly arranged in the light box body with the internal power socket and the internal signal socket to prevent the signal decay due to the sharing of hub by control apparatus and the image capture apparatus, and the problem of failing to turn on the light and find the image capture apparatus is avoided.

It is therefore another objective of the claimed invention to provide an enhanced structure of a photo light box that utilizes a movable or rotatable fixing base to fix the lens, and the image capture apparatus of different types can be all equipped on the photo light box and using the same photo light box.

It is therefore a further objective of the claimed invention to provide an enhanced structure of a photo light box that the power and signal cables of the image capture apparatus can be directly plugged into the internal power and signal sockets in the placing space without connecting the external power socket and the computer. And even the signal cable of the image capture apparatus can indirect connect with the computer through the signal socket, or direct connect with the computer through the hole that is on the light box.

It is therefore a further objective of the claimed invention to provide an enhanced structure of a photo light box that the image capture apparatus can be inlaid into the placing gateway of the placing space, and the image capture apparatus need not be fixed on the fixing stand at a fixing position and need not be equipped on the frame upon the photo light box to take pictures.

It is therefore a further objective of the claimed invention to provide an enhanced structure of a photo light box with multiple purposes that can equip the light source at bottom of the light box body and place the X-ray film at bottom of the light box body, and the x-ray film can be shot to produce a digital image with the image capture apparatus.

For achieving the intention, the present invention discloses an enhanced structure of a photo light box including a light box body having a placing space in which formed a placing gateway. A power socket and at least one signal sockets are formed on surface of the light box body for separately connecting an external power socket and a computer. An opening is formed on the light box body for placing a photo object, and a lens of an image capture apparatus is inlaid in the placing gateway. The image capture apparatus includes a power cable and a signal cable, and the lens of the image capture apparatus is aimed at internal of the light box body for shooting the photo object and producing an image. The power cable and the signal cable provide the image capture apparatus with power and control signals and transmit the image to the computer. In addition, an internal power socket is designed in the light box body and in the placing space for providing the power cable of the image capture apparatus to connect to, and a light source is located in the light box body for providing the image capture apparatus with light while shooting the photo object.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of the appearance of a photo light box according to the present invention

FIG. 2 is a top view of the photo light box according to the present invention.

FIG. 3 is a schematic diagram of an indent formed in the placing space according to the present invention.

FIG. 4 is a schematic diagram of a concentric circles pattern on the cushion.

FIG. 5 is a partially side view of a sliding track formed in the light box body according to the present invention.

FIG. 6 is a schematic diagram of a movement status of the movable chuck according to the present invention.

FIG. 7 is a schematic diagram of another movement status of the movable chuck according to the present invention.

FIG. 8 is a schematic diagram of another movement status of the movable chuck according to the present invention.

| | |
|---|---|
| 20 | photo light box |
| 202 | light box body |
| 204 | placing space |
| 206 | placing gateway |
| 207 | indent |
| 208 | power socket |
| 210 | signal socket |
| 212 | external power socket |
| 214 | computer |
| 216 | image capture apparatus |
| 218 | power cable |
| 220 | signal cable |
| 222 | internal power socket |
| 224 | internal signal socket |
| 225 | control cable |
| 226 | light source |
| 228 | control apparatus |
| 229 | control signal cable |
| 230, 232, 234 | power cable |
| 235 | sliding track |
| 236-254 | movable chuck |
| 237 | cushion |
| 239 | concentric circles pattern |

### DETAILED DESCRIPTION

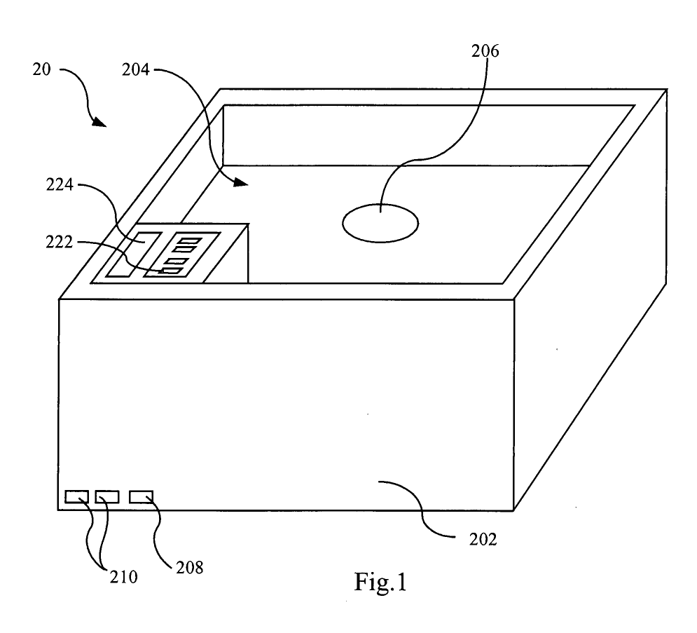

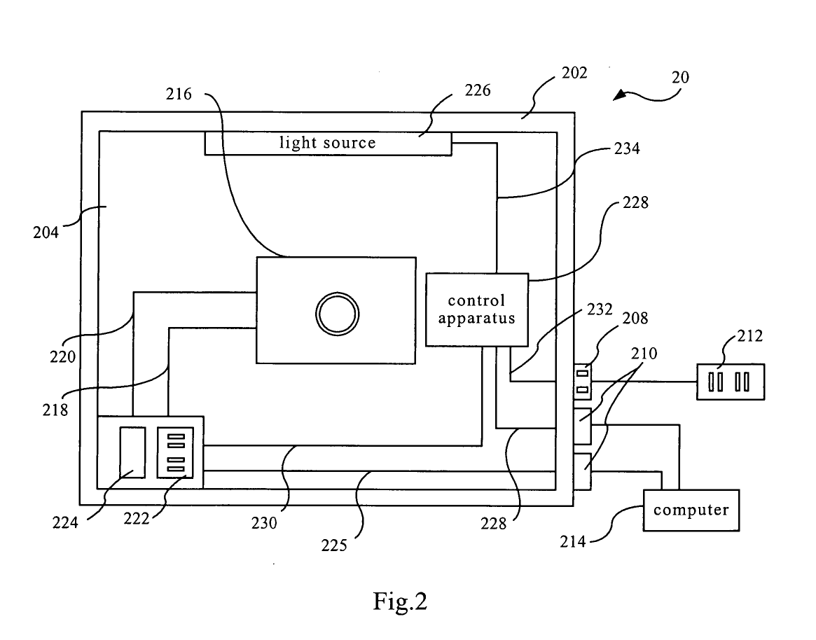

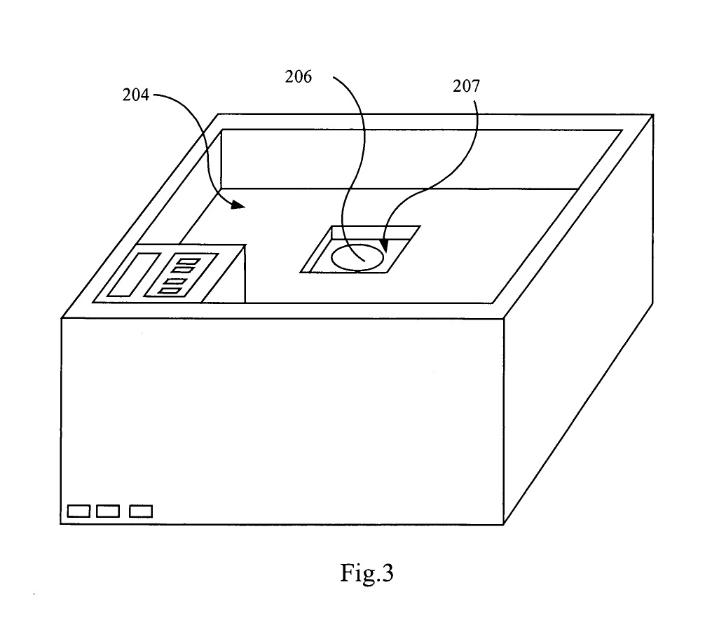

The present invention discloses an enhanced structure of a photo light box. FIG. 1 is a schematic diagram of the appearance of a photo light box according to the present invention, and FIG. 2 is a top view of the photo light box. The photo light box 20 includes a light box body 202 having a placing space 204, and the placing space 204 is formed a placing gateway 206. Or as FIG. 3 shows, an indent 207 is formed in the placing space 204, and the placing gateway 206 is formed in the indent 207. A power socket 208 and at least one signal sockets 210 or a hole are formed on surface of the light box body 202. The power socket 208 and the signal socket 210 separately connect an external power socket 212 and a computer 214, and an opening is formed on the light box body 202 for placing a photo object (not shown). An image capture apparatus 216, such as a digital camera or a video camera, is placed at top or inlaid at bottom of the placing gateway 206. A lens of the image capture apparatus 216 is aimed at internal of the light box body 202 for shooting the photo object and producing an image, and the image capture apparatus 216 includes a power cable 218 and a signal cable 220. The power cable 218 and the signal cable 220 provide the image capture apparatus 216 with power and control signals and transmit the image of the photo object, and are connected to an internal power socket 222 and an internal signal socket 224. The internal signal socket 224 is connected to the signal socket 210 via the signal cable 225, and the internal signal socket 224 can be also omitted instead of a hole on the light box body 202. The signal cable 220 can be connected to the computer 214 via the hole. A light source 226 and a control apparatus 228, such as a control card, are designed in the light box body 202 for providing the image capture apparatus 216 with light while shooting the photo object. The control apparatus 228 is connected to the internal power socket 222, the power socket 208 and the light source 226 via the power cables 230, 232, and 234, and a control signal cable 229 is connected to the signal socket 210. The signal cables 220, 225 and the control signal cable 229 can be universal serial bus (USB) RS232, or IEEE1394.

Wherein, the light source 226 can be formed on bottom of the light box body 202, and the X-ray film can be placed onto bottom of the light box body 202 and be photographed with the light source 226 and the image capture apparatus 216 to produce the digital images. The digital images can be transmitted to the computer 214 for medical purposes, and the digitalized X-ray films can be preserve longer.

A cover (not shown) further covers the placing space 204, and size of the cover is equal to or smaller than the placing space 204 for making the placing space 204 as an enclosure or exposing portion of the placing space 204. Or a hollow cover (not shown) can be also used on the light box body 202 to form the placing space 204, or a shade (not shown) is used to cover the opening for preventing light leakage.

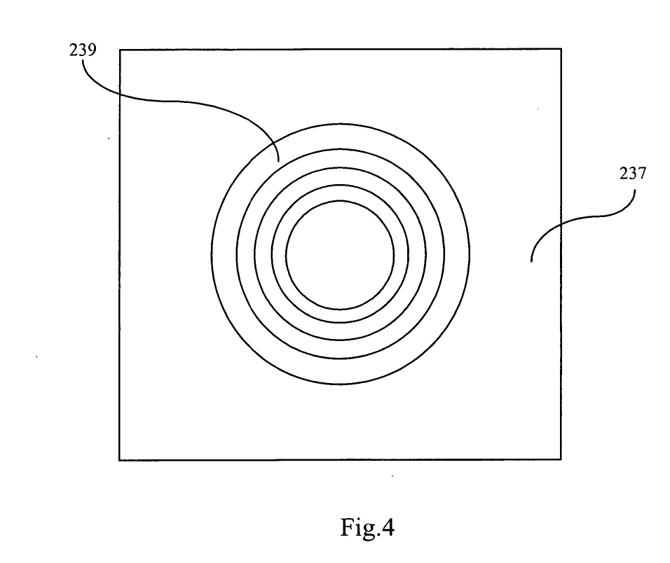

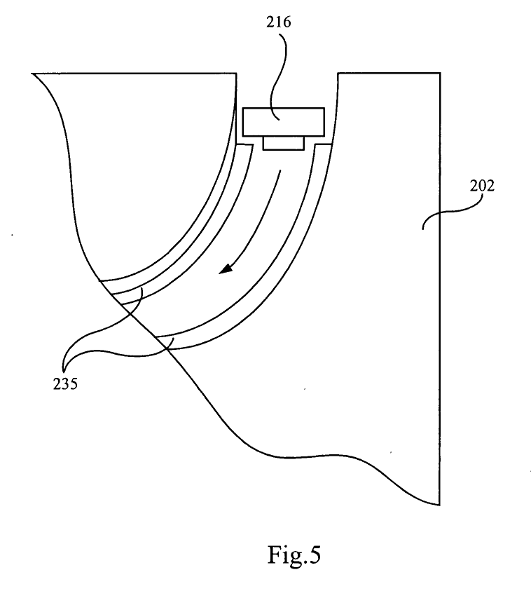

In addition, a strap across the placing space 204 is designed on the light box body 202 or in the placing space 204 for fixing the image capture apparatus 216 with binding or buckling way when inlaid at the placing gateway 206. Several cushions 234 with cushion effect, such as the foamed plastic, can be further formed in the placing space 204. As shown in FIG. 4, these cushions 237 are marked a concentric circles pattern 239 in advance for holing in accordance with size of the lens of the image capture apparatus 216. The lens is inlaid at the hole and passes through the placing gateway 206, and the hole can be formed in advance or in accordance with size of the lens. When the image capture apparatus 216 is inlaid at the placing gateway 206, the lens can be fixed. As shown in FIG. 5, a sliding track 235 is formed in the light box body 202, and the image capture apparatus 216 can slide to a fixed height along the sliding track 235 to perform a side shooting of the photo object in the light box body.

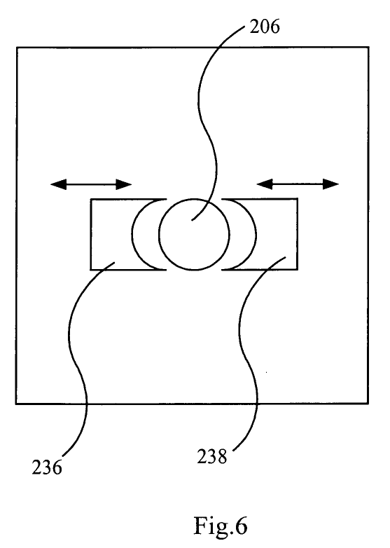

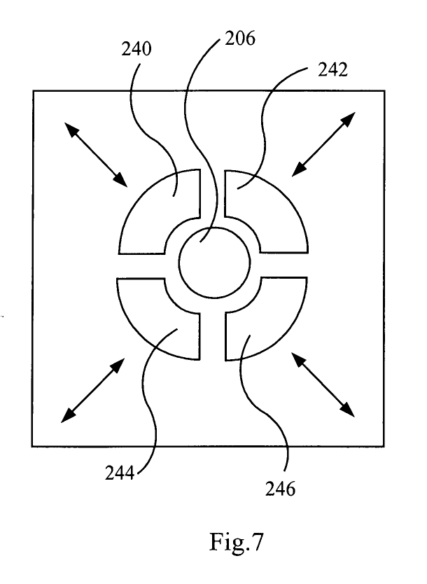

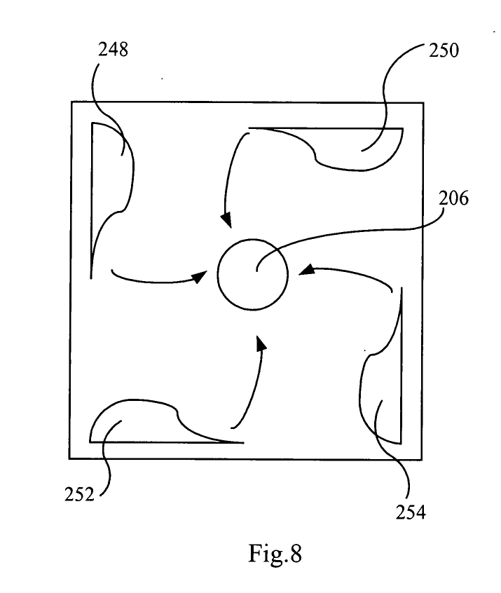

For applying the photo light box 20 to the image capture apparatus 216 of different types, a fixing base, which can be moved or rotated, is formed in the placing space 204 for fixing the lens. When the fixing bases are close, the lens with different sizes can be all fixed in them. With fixing the lens, the image capture apparatus 216 can be also fixed. So the fixing bases are suitable for the image capture apparatus 216 of different types. Please refer to FIG. 6, the fixing base is movable, and two movable chucks 236, 238 are used to fix the lens. The movable chucks 236, 238 can be moved laterally or lengthwisely to approach the placing gateway 206. Or as shown in FIG. 7, the fixing base can be composed of four movable chucks 240, 242, 244 and 246. These four movable chucks 240, 242, 244 and 246 are radially moved to approach the placing gateway 206. Or as shown in FIG. 8, the movable chucks 248, 250, 252 and 254 are rotatively moved to approach the placing gateway 206 to fix the lens.

Since type of the image capture apparatus is various and changes rapidly, the present invention makes different image capture apparatus can all use a same photo light box, and integrates the photo light box and the image capture apparatus to popularize the high quality images. At least one signal sockets or a hole dedicated to connect the signal cable of the image capture apparatus to the computer, so that the signal decay can be prevented and the problem of failing to turn on the light and find the image capture apparatus is avoided. The internal power is designed in the placing space, so that image capture apparatus of different types can use the power and the signal cable can through the internal signal socket indirectly connecting to the computer, or instead with a hole allowing the signal cable direct connected to the computer. The lens of the image capture apparatus can be placed through the placing gateway without using the fixing stand or frame to fix the image capture apparatus, and is suitable for the image capture apparatus of different types with using the movable or rotatable fixing base. The light source is designed on bottom of the light box body, and the X-ray films are photographed with the image capture apparatus, so that the digitalized X-ray films can be preserved long and can be checked convenient.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An enhanced structure of a photo light box comprising:
a light box body having at least a placing space, the placing space is formed a placing gateway, at least a power socket and at least one signal sockets are formed on surface of the light box body for separately connecting an external power socket and a computer, and an opening is formed on the light box body for placing a photo object;
a light source located in the light box body for providing the image capture apparatus with light while shooting the photo object.

2. The enhanced structure of the photo light box of claim 1 further comprising an image capture apparatus including a power cable and a signal cable, the image capture apparatus is placed in the placing space and a lens of the image capture apparatus is aimed at internal of the light box body via the placing gateway for shooting the photo object and producing an image, the power cable and the signal cable provide the image capture apparatus with power and control signals and transmit the image to the computer.

3. The enhanced structure of the photo light box of claim 2 further comprising an internal power socket formed in the placing space of the light box body for providing the power cable of the image capture apparatus to plug onto.

4. The enhanced structure of the photo light box of claim 1 further comprising a hole formed on the light box body, the signal cable is connected to the computer via the hole.

5. The enhanced structure of the photo light box of claim 1, wherein the light source is formed on bottom of the light box body.

6. The enhanced structure of the photo light box of claim 1 further comprising a hollow cover formed on the light box body to form the placing space.

7. The enhanced structure of the photo light box of claim 6, wherein the image capture apparatus is inlaid at bottom of the hollow cover.

8. The enhanced structure of the photo light box of claim 1 further comprising a cover covering surface of the light box body and on the placing space for exposing portion of the placing space.

9. The enhanced structure of the photo light box of claim 1, wherein the signal cable is selected from universal serial bus (USB), RS232, and IEEE1394.

10. The enhanced structure of the photo light box of claim 2, wherein the image capture apparatus is one of digital camera and video camera.

11. The enhanced structure of the photo light box of claim 2 further comprising a strap formed on the light box body for fixing the image capture apparatus.

12. The enhanced structure of the photo light box of claim 2 further comprising a strap formed in the placing space for fixing the image capture apparatus.

13. The enhanced structure of the photo light box of claim 1 further comprising at least one cushions formed in the placing space for fixing the lens while the image capture apparatus put into the placing gateway.

14. The enhanced structure of the photo light box of claim 1 further comprising a fixing base formed in the placing space for fixing the lens.

15. The enhanced structure of the photo light box of claim 14, wherein the fixing base is composed of two movable chucks, these movable chucks are formed in the placing space and can be moved to approach the placing gateway.

16. The enhanced structure of the photo light box of claim 15, wherein these movable chucks are moved to approach the placing gateway by one of lateral movement, lengthwise movement and radial movement.

17. The enhanced structure of the photo light box of claim 15, wherein these movable chucks are moved to approach the placing gateway by rotation movement with a module of the rotative structure.

18. The enhanced structure of the photo light box of claim 2, wherein the image capture apparatus is placed at top of the placing space or is inlaid at bottom of the placing space.

19. The enhanced structure of the photo light box of claim 1, wherein further comprises an indent formed in the placing space, and the placing gateway is formed in the indent.

20. The enhanced structure of the photo light box of claim 2 further comprising a sliding track formed in the light box body and under the placing space, the image capture apparatus can slide to a fixed height along the sliding track to perform a side shooting of the photo object in the light box body.

21. The enhanced structure of the photo light box of claim 1 further comprising at least one power cable on the light box which has a plug at the end for plugging onto the external power socket.
